(19) United States
(12) Patent Application Publication
(10) Pub. No.: US 2020/0380290 A1
(43) Pub. Date: Dec. 3, 2020

(54) MACHINE LEARNING-BASED PREDICTION OF PRECISE PERCEPTUAL VIDEO QUALITY

(71) Applicant: Apple Inc., Cupertino, CA (US)

(72) Inventors: Pranav SODHANI, Cupertino, CA (US); Steven E. Saunders, Cupertino, CA (US); Bjorn Hori, Cupertino, CA (US); Rahul Gopalan, Cupertino, CA (US); Krasimir Kolarov, Cupertino, CA (US); Samira Tavakoli, Cupertino, CA (US)

(21) Appl. No.: 16/428,577

(22) Filed: May 31, 2019

(51) Int. Cl. G06K 9/46; H04N 17/00; H04N 19/154; G06K 9/00; G06N 20/00

(52) U.S. Cl. CPC G06K 9/4676; H04N 17/004; G06N 20/00; G06K 9/00744; H04N 19/154

(57) ABSTRACT

Systems and Methods disclosed for measuring a similarity between the input and the output of computing systems and communications channels. Techniques disclosed provide for low complexity prediction method of a perceptual video quality (PVQ) score, which may be used to design and tune performance of the computing systems and communications channels.

### BACKGROUND

Video data tends to possess temporal and/or spatial redundancies which can be exploited by compression algorithms to conserve bandwidth for transmission and storage. Video data also may be subject to other processing techniques, even if not compressed, to tailor them for display. Thus, video may be subject to a variety of processing techniques that alter video content. Oftentimes, it is desired that video generated by such processing techniques retains as much quality as possible. Estimating video quality tends to be a difficult undertaking because the human visual system recognizes some alterations of video more readily than others.

Effective Video Quality Metrics (VQMs) are those that are consistent with the evaluation of a human observer and at the same time have low computational complexity. A common approach taken in the development of a VQM is to compare a video sequence (a “reference video,” for convenience) at the input of a system employing video processing with the video sequence (a “test video”) at the output of that system. Similarly, that comparison may be made between the input of a channel through which the video is transmitted and the output of that channel. The resulting VQM may then be used to tune the system (or the channel) parameters and to improve its performance and design.

Typically, a VQM prediction involves a two-step framework. First, local similarity metrics (or distance metrics) between corresponding reference and test image regions are computed, and, then, these computed local metrics are combined into a global metric. This global metric is indicative of the distortions the system (or the channel) has introduced into the processed (or the transmitted) video sequence.

Existing VQMs such as Structural SIMilarity (SSIM) index, Peak to Signal Noise Ratio (PSNR), Mean Squared Error (MSE) may not be computationally intensive, however they lack perceptual accuracy—they do not correlate well with video quality scores rated by human observers. On the other hand, Video Multi-method Assessment Fusion (VMAF), although resulting in a better perceptual accuracy, incurs a high computational cost. Hence, there is a need for a new VQM that is both perceptually accurate and computationally efficient.

### BRIEF DESCRIPTION OF THE DRAWINGS

FIG. 1 illustrates a video system according to an aspect of the present disclosure.

FIG. 2 illustrates a system for generating a Perceptual Video Quality (PVQ) score according to aspects of the present disclosure.

FIG. 3 is a functional block diagram illustrating generation of features according to aspects of the present disclosure.

FIG. 4 illustrates a configuration for measuring a relative PVQ score between two videos according to aspects of the present disclosure.

FIG. 5 is a simplified block diagram of a processing device according to an aspect of the present disclosure

### DETAILED DESCRIPTION

Aspects of the present disclosure provide for systems and methods for measuring a similarity between a test video and a reference video. In an aspect, the disclosed method may compute pairs of gradient maps representing content changes within frames of the test video and the reference video. Each pair may constitute a gradient map of a frame of the test video and a gradient map of a corresponding frame of the reference video. Quality maps may then be computed based on the pairs of gradient maps. The method may identify saliency regions of frames of the test video. Then a video similarity metric may be derived from a combination of the quality maps, using quality maps' values within the identified saliency regions. Based on this similarity metric, a perceptual video quality (PVQ) score is predicted using a classifier.

In an aspect, the reference video may be the input of a system and the test video may be the output of the system, wherein the predicted PVQ score may be used to adjust the parameters or the design of the system. For example, the system may be a video processing system that may perform enhancement or encoding operations over the reference video, resulting in the test video. In another aspect, the system may be a communication channel, transmitting the reference video to a receiving end, receiving the test reference, wherein the predicted PVQ score may be used to adjust the parameters of the channel.

Aspects of the present disclosure describe machine learning techniques for predicting a PVQ score. Methods disclosed herein may facilitate optimization of the performance and the design of video systems and video transmission channels. For example, coding processes that generate low PVQ scores may be revised to select a different set of coding processes, which might lead to higher PVQ scores. Moreover, the low computational cost and the perceptual accuracy of the herein devised techniques allow for on-the-fly prediction of PVQ scores that may enable tuning of live systems as they are processing and/or transmitting the video stream whose quality is being determined.

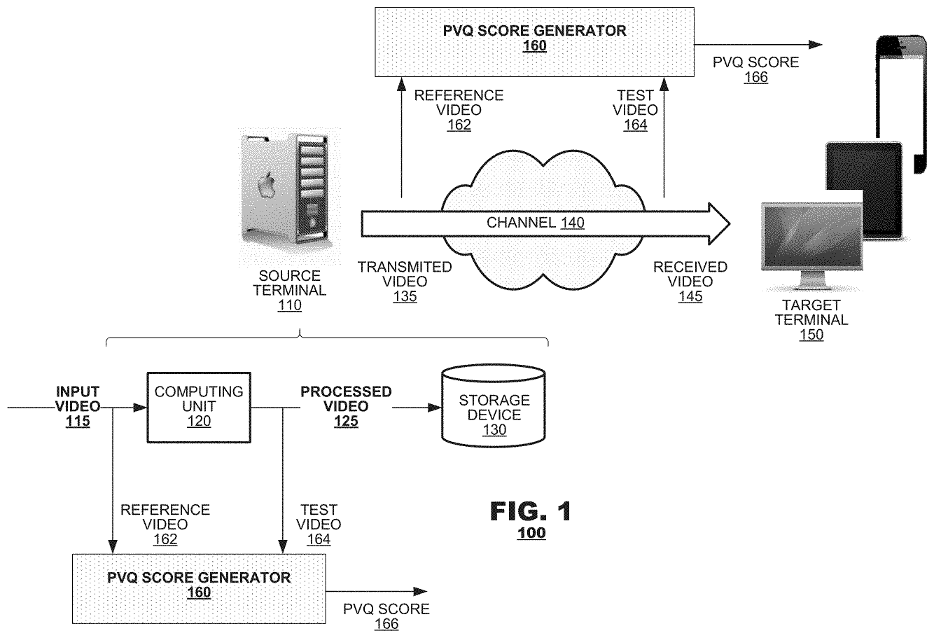

FIG. 1 illustrates a video system 100 according to an aspect of the present disclosure. The system 100 may include a source terminal 110, in communication via a network 140 with a target terminal 150. The source terminal 110 may capture an input video 115 or may obtain the input video 115 from another source, and, then, a computing unit 120 may process and store the processed video 125 in a storage device 130. The computing unit 120 may process the input video 115, employing various technologies pertaining to video enhancements and video compression (to accommodate network bandwidth or storage limitations). The source terminal 110 may transmit a video 135 (either before processing 115 or post processing 125) through the network 140 to the target terminal 150. The received video 145 may then be displayed on the target terminal 150, stored, further processed, and/or distributed to other terminals.

The PVQ scores 166 disclosed herein may measure the video quality of the processed video 125 (test video 164) relative to the input video 115 (reference video 162), employing a PVQ score generator 160, resulting in a PVQ score 166. Such measures may assess the distorting effects of the processing operations carried out by the computing unit. Knowledge of these distorting effects may allow the optimization of the carried-out processing operations.

In an alternate aspect, the PVQ scores 166 disclosed herein may measure the video quality of the received video 145 (test video 166) relative to the transmitted video 135 (reference video 162), employing the PVQ score generator 160. Such measures may assess the distorting effects of the network's channel 140 and may provide means to tune the channel's parameters or to improve the channel's design.

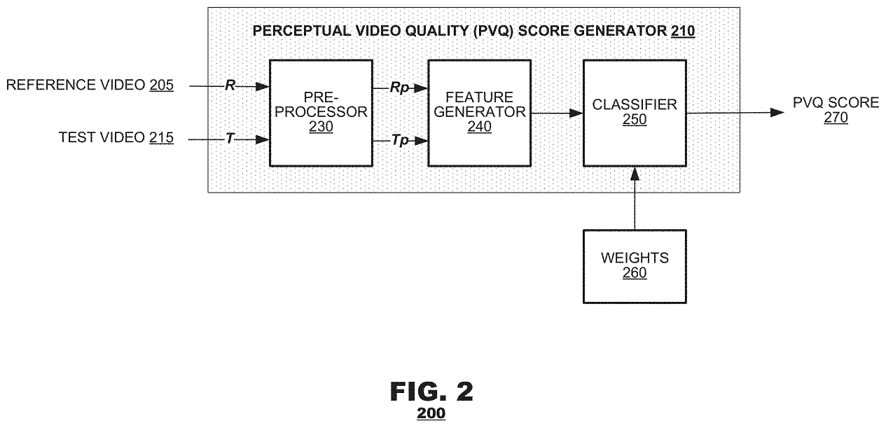

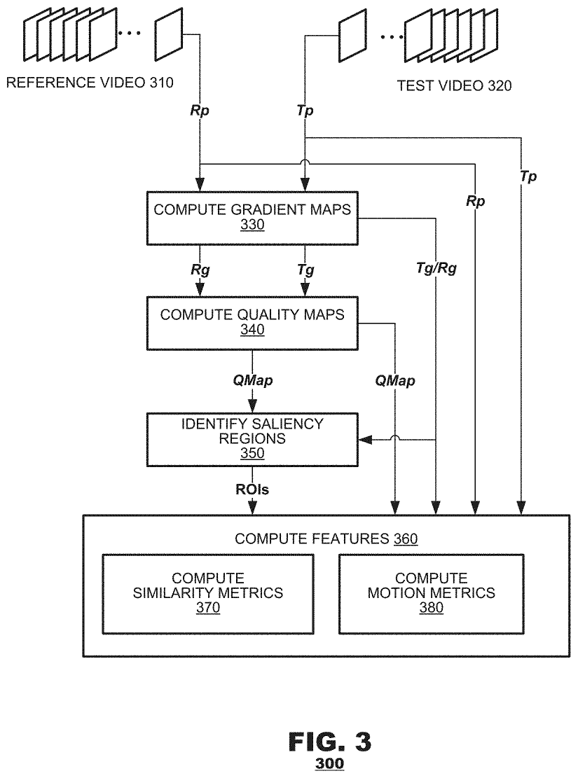

FIG. 2 illustrates a system 200 for generating PVQ scores according to an aspect of the present disclosure. A PVQ score generator 210 (i.e., 160) may receive a reference video 205 and a test video 215. These reference and test videos may be first preprocessed 230. Next, a feature generator 240 may extract features out of the pre-preprocessed reference and test videos. Further aspects of generation of features are disclosed below in conjunction with FIG. 3. Then, the generated features may be provided to a classifier 250. Based on weights 260 generated by a training process and the provided features, the classifier may derive a PVQ score 270. The PVQ score 270 may be a in a numerical range (say, 1 to 5), indicating a quality measure of the test video 215—or how perceptually similar the test video 215 and the reference video 205 are.

The preprocessor 230 may process the received reference video 205, denoted R, and the received test video 215, denoted T, and may deliver the processed video sequences, Rₚ and Tₚ, to the feature generator 240. The R and T video sequences may consist of N corresponding frames, where each frame may include luminance and chrominance components. The pre-processor 230 may prepare video sequences R and T to the next step of feature extraction 240. Alternatively, the R and T video sequences may be delivered as is to the feature generator 240. In an aspect, the preprocessing of R and T may include filtering (e.g., low-pass filtering) and subsampling (e.g., by a factor of 2) of the luminance components, resulting in the processed video sequences of Rₚ and Tₚ, respectively.

The classifier 250 may be a supervised classifier. For example, linear regression classifiers, support vector machines, or neural networks may be used. The classifier's parameters may be learned in a training phase, resulting in the values of the weights 260. These learned weights may be used to set the parameters of the classifier 250 when operating in a test phase—i.e., real time operation. Training is performed by introducing to the classifier examples of reference and test video sequences and respective perceptual video quality (PVQ) scores, scored by human observers (ground truth). According to an aspect, the classifier 250 may comprise a set of classifiers, each trained to a specific segment of the video sequence. For example, different classifiers may be trained with respect to different image characteristics (foregrounds versus backgrounds). Furthermore, different classifiers may be trained with respect to different types or modes of processing 120 or types or modes of channels 140.

FIG. 3 is a functional block diagram illustrating a method for feature extraction 240 according to an aspect of the present disclosure. In step 330, gradient maps, denoted R_{g} and T_{g}, may be computed from the preprocessed reference video 310 and the preprocessed test video 320, respectively. The R_{g} and T_{g} gradient maps represent changes in neighboring pixels' value in the respective Rₚ and Tₚ images. In the next step 340 a quality map, QMap, may be computed based on the computed gradient maps R_{g} and T_{g}. This quality map may represent pixelwise similarity between a reference frame R and its test frame counterpart T measured based on their respective gradient maps. In step 350, saliency regions may be determined across frames of the test video sequence, defining Regions of Interest (ROIs). ROIs may be selected to include regions in the frame with strong gradients or regions in the frame with visible artifacts, for example. Then, features may be extracted 360 based on data from the test and reference videos, including the computed images of Rₚ, Tₚ, R_{g}, T_{g} and QMap; data used to compute the features may be aggregated relative to the identified saliency regions 350. For example, features extracted may comprise GMSDPlus and motion metrics as described further below.

In an aspect, gradient maps may be computed 330 for respective pairs of corresponding test and reference frames. Accordingly, the gradient maps, R_{g} (i) and T_{g} (i), may be computed respectively out of Rₚ (i) and Tₚ (i), for corresponding frames: i=1, . . . N, using gradient kernels. A variety of gradient kernels may be used, such as the kernels of Roberts, Sobel, Scharr, or Prewitt. For example, the following 3×3 Prewitt kernel may be used:

$${k}_{x} = \frac{1}{3} [ \begin{matrix}1 & 0 & - 1 \\ 1 & 0 & - 1 \\ 1 & 0 & - 1\end{matrix} ] and$$

$${k}_{y} = \frac{1}{3} [ \begin{matrix}1 & 1 & 1 \\ 0 & 0 & 0 \\ - 1 & - 1 & - 1\end{matrix} ] .$$

The gradient maps, R_{g} (i) and T_{g} (i), may then be generated by convolving (i.e., filtering) each kernel with each pair of corresponding frames Rₚ (i) and Tₚ (i), as follows:

$${R}_{g} ( i ) [ x , y ] = \sqrt{{( {R}_{p} ( i ) ⊗ {k}_{x} ) [ x , y ]}^{2} + {( {R}_{p} ( i ) ⊗ {k}_{y} ) [ x , y ]}^{2}} , and$$

$${T}_{g} ( i ) [ x , y ] = \sqrt{{( {T}_{p} ( i ) ⊗ {k}_{x} ) [ x , y ]}^{2} + {( {T}_{p} ( i ) ⊗ {k}_{y} ) [ x , y ]}^{2}} ,$$

where x and y denote a pixel location within a frame.

Following the computation of the gradient maps, a quality map QMap may be computed 340 based on a pixel-wise comparison between the gradients R_{g} (i)[x, y] and T_{g}(i)[x, y]. For example, a quality map may be computed as follows:

$$QMap ( i ) [ x , y ] ≡ \frac{2 {R}_{g} ( i ) [ x , y ] {T}_{g} ( i ) [ x , y ] + c}{{R}_{g}^{2} ( i ) [ x , y ] + {T}_{g}^{2} ( i ) [ x , y ] + c} ,$$

where c is a constant. In an exemplary system that processes 8-bit depth video, c may be set to 170. In an aspect, QMap(i)[x,y] may represent the degree in which corresponding pixels, at location [x, y], from the reference video and test video, relate to each other, thus, providing a pixelwise similarity measure.

Generally, a global (frame-level) similarity metric may be derived from the obtained local (pixel-wise) similarity metric, represented by QMap, based on the sample mean as follows:

$$QMap ( i ) = \frac{1}{X Y} {\sum }_{x = 1}^{X} {\sum }_{y = 1}^{Y} QMap ( i ) [ x , y ] ,$$

where X and Y represent the frame dimensions. Alternatively, a global similarity metric may be derived based on the sample standard deviation, for example, the Gradient Magnitude Similarity Deviation (GMSD):

$$GMSD ( i ) = \sqrt{\frac{1}{X Y} {\sum }_{x = 1}^{X} {\sum }_{y = 1}^{Y} {( Q M a p ( i ) [ x , y ] - Q M a p ( i ) )}^{2}} .$$

Aspects of the present disclosure may augment the GMSD metric, devising a new metric, called “GMSDPlus” for convenience, for video quality assessment. GMSD was proposed for still images, not video, thus, it does not account for motion picture information. The proposed GMSDPlus metric may be used cooperatively with other features, such as motion metrics, and may be fed into a classifier. The classifier may be trained on training datasets, including videos and respective quality assessment scores provided by human observers. PVQ scores derived therefrom may be computationally less demanding and may outperform existing video quality metrics in terms of their perceptual correlation with human vision. In an implementation of an aspect, a significant computational improvement has been achieved compared with state of the art video quality techniques. Hence, aspects of computing the PVQ scores disclosed herein may be a preferable choice for practical video quality assessment applications.

In other aspects, PVQ scores may be developed from supervised classifiers, such as a linear Support Vector Machine (SVM), to derive a PVQ score of a test video sequence relative to a reference video sequence. According to aspects disclosed herein, such classifiers may be trained based on features extracted from saliency regions of the video. For example, saliency regions associated with regions in the frames having strong gradients or visible artifacts may be used.

According to aspects of this invention, for each video frame a local similarity metric QMap may be pooled to form a frame-level quality metric by considering only saliency regions. Hence, saliency regions may be derived for each frame 350—i.e., one or more ROIs that each may include a subset of pixels from that frame. Each frame's ROIs may be defined by a binary mask M(i), wherein pixels at locations [x, y] for which M(i) [x, y]≠0 may be part of an ROI. ROIs may be selected to include regions in the frame with strong gradients, for example, regions where the T_{g} (i) [x, y] values are above a certain threshold g. Similarly, ROIs may be selected to include regions in the frame with lower quality (e.g., visible artifacts), for example, regions where the QMap(i)[x, y] values are below a threshold q. Thus, M(i) may be set as follow:

M (i)[x, y]=1 for T_{g} (i)[x, y]>g or QMap (i)[x, y]<q;

M (i)[x, y]=0, otherwise.

The resulting binary map, M(i), may be further filtered to form a continuous saliency region. In an aspect, M(i) may be computed based on any combination of T, R, Tₚ, Rₚ, T_{g}, R_{g}and/or QMap. Furthermore, M(i) may assume a value between 0 and 1 that reflects a probability of being part of a respective ROI.

Next, features may be generated 360 to be used by the classifier 250. Various features may be computed from data derived from the reference and test videos, such as the described above images of T, R, Tₚ, Rₚ, T_{g}, R_{g}, and QMap. In an aspect, the feature(s) computed may comprise a similarity metric 370, such as GMSDPlus. First, a GMSDPlus(i) may be computed for each corresponding reference and test frame using sample standard deviation of QMap (i)[x, y] values, wherein values corresponding to pixels within saliency regions contribute to the computation. Thus, GMSDPlus(i) may be computed as follows:

$$GMSDPlus ( i ) = \sqrt{\frac{1}{X Y} {\sum }_{x = 1}^{X} {\sum }_{y = 1}^{Y} M ( i ) [ x , y ] {( Q M a p ( i ) [ x , y ] - Q M a p ( i ) )}^{2}} .$$

A video similarity metric, GMSDPlus, may then be obtained by combining the GMSDPlus(i) values across frames. For example, GMSDPlus may be derived by employing any functional: f(GMSDPlus(i),i=1, . . . ,N) or by simply taking the average:

$$GMSDPlus = f ( GMSDPlus ( i ) , i = 1 , … , N ) = \frac{1}{N} {\sum }_{i = 1}^{N} GMSDPlus ( i )$$

According to an aspect, saliency regions of each frame may be identified based on different characteristics of the video image, allowing for multiple categories of saliency regions. Accordingly, a first category of saliency regions may be computed to capture foreground objects (e.g., faces or human figures), a second category of saliency regions may be computed to capture background content (e.g., the sky or the ground). Yet, a third category of saliency regions may be computed to capture regions of the video with motions within a certain range or of a certain attribute. Consequently, multiple video similarity metrics (e.g., GMSDPlus) may be generated, each computed within a different saliency region category. These multiple video similarity metrics may then be fed into a classifier 250 for the prediction of a PVQ score 270.

In another aspect, feature(s) may be extracted from the video based on computation of motion 380. The degree of motion present in a video may correlate with the ability of a human observer to identify artifacts in that video. Accordingly, high motion videos with low fidelity tend to get higher quality scores by human observers relative to low motion videos with the same level of low fidelity. To account for this phenomenon, motion metrics may also be applied at the input to the classifier 250. A motion metric may be derived from motion vectors. Motion vectors, in turn, may be computed for each video frame based on optical field estimations or any other motion detection method. The motion vectors associated with a frame may be combined to yield one motion metric that is representative of that frame. For example, a frame motion metric, MM(i), may be computed by, first, computing the absolute difference between corresponding pixels in each two consecutive reference frames, and, then, averaging these values across the frame as follows:

$$MM ( i ) = \frac{1}{X Y} {\sum }_{x = 1}^{X} {\sum }_{y = 1}^{Y} \vert R ( i ) [ x , y ] - R ( i - 1 ) [ x , y ] \vert .$$

MM(i) may be computed within regions of interest determined by M(i). For example, MM(i) may be computed as follows:

$$MM ( i ) = \frac{1}{X Y} {\sum }_{x = 1}^{X} {\sum }_{y = 1}^{Y} M ( i ) [ x , y ] \vert R ( i ) [ x , y ] - R ( i - 1 ) [ x , y ] \vert .$$

The overall motion of the video sequence may be determined by pooling the frames' motion metrics, for example, by simply using the sample mean as follows:

$$M M = f ( M M ( i ) , i = 1 , … , N ) = \frac{1}{N} {\sum }_{i = 1}^{N} MM ( i )$$

Features generated by the feature generator 240, such as the similarity metrics 370 and motion metrics 380 described above, may be fed to the classifier 250. The classifier, based on the obtained features and the classifier's parameters (weights 260) may predict a PVQ score, indicative of the distortion the test video incurred as a result of the processing 120 or the transmission 140 the reference video went through.

In an aspect, prediction of the PVQ score may be done adaptively along a moving window. Thus, computation of features such as GMSDPlus and MM may be done with respect to a segment of frames. In this case, PVQ(t), denoting a PVQ score with respect to a current frame t, may be computed based on the previous N frames within the range of t-N and t-1. Having adaptive prediction of the PVQ score, PVQ(t), may allow adjustments of the system's 120 or channel's 140 parameters as the characteristics of the video change over time. Furthermore, in a situation where the mode of operation of the system 120 or the channel 140 changes over time, adaptive PVQ scoring may allow real-time parameter adjustments of that system or channel.

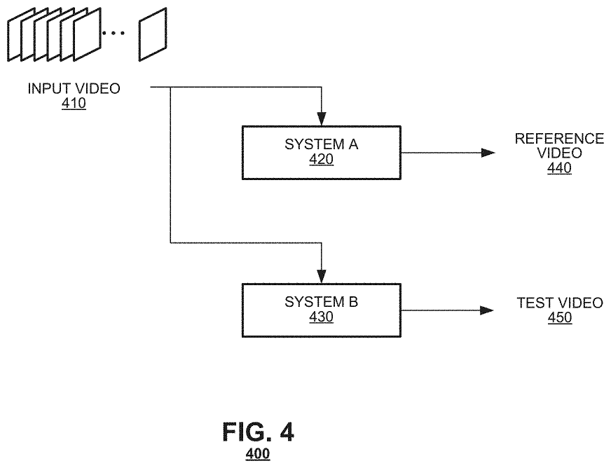

Aspects disclosed herein include techniques wherein the relative quality of two video sequences, undergoing two respective processing operations, may be predicted. FIG. 4 illustrates a configuration 400 wherein a relative PVQ score between two videos may be predicted according to an aspect of the present disclosure. Therein, system A 420 and system B 430 may be employing comparable processing operations on an input video 410. For example, these systems may be employing coding (or enhancing) operations that may process the input video 410 according to two respective compression (or enhancement) techniques. Or, the two processing operations may be executing the same algorithm, however with different parameter settings. Alternatively, systems A 420 and B 430, may be represented by communication channels, distinguishable from each other by their protocols or any other characteristics that may affect the quality of the transmitted signal 410. In such a configuration 400 a relative PVQ score may be computed according to aspects described above with respect to the reference video 440 and the test video 450. Predicting such a relative PVQ may facilitate comparison between system A 420 and system B 430 and may inform tuning and/or design related decision making.

For example, system A 420 and system B 430 may be video encoders with different parameter settings. Given a video sequence whose visual quality needs to be estimated, first, a low quality encoded version of the input video 410 may be generated by system A 420 (e.g., by selecting baseline parameter settings), resulting in the reference video 440. Second, another encoded version of the input video 410 may be generated by system B 430 at a desired quality (e.g., by selecting test parameter settings), resulting in the test video 450. The perceptual distance between the reference and the test videos (associated with the difference between the baseline and test parameter settings) may be measured by the resulting PVQ score. Thus, the resulting PVQ score, may provide insight as to the effects that the different encoder parameter settings may have on the quality of the encoded video. Furthermore, since in this configuration the generated reference video is of lower quality, the higher the perceptual distance is (i.e., the lower the PVQ score), the higher the quality of the test video 450 is.

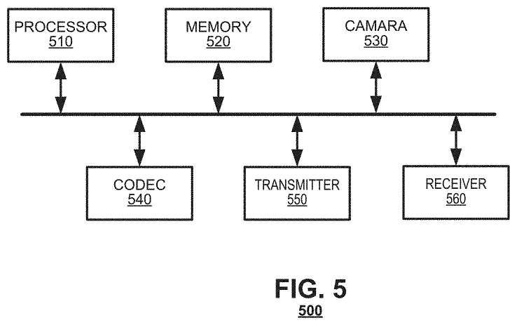

FIG. 5 is a simplified block diagram of a processing device 500 that generates PVQ scores according to an aspect of the present disclosure. As illustrated in FIG. 5, the terminal 500 may include a processor 510, a memory system 520, a camera 530, a codec 540, a transmitter 550, and a receiver 560 in mutual communication. The memory system 520 may store program instructions that define operation of a PVQ score estimation system as discussed in FIGS. 2-4, which may be executed by the processor 510. The PVQ estimation processes may analyze test videos and reference videos that may be captured by the camera 530, encoded and decoded by the codec 540, received by the receiver 560, and/or transmitted by the transmitter 550.

Implementations of the processing device 500 may vary. For example, the codec 540 may be provided as a hardware component within the processing device 500 separate from the processor 510 or it may be provided as an application program (labeled 540′) within the processing device 500. The principles of the present invention find application with either embodiment.

As part of its operation, the processing device 500 may capture video via the camera 510, which may serve as a reference video for PVQ estimation. The processing device 500 may perform one or more processing operations on the reference video, for example, by filtering it, altering brightness or tone, compressing it, and/or transmitting it. In this example, the camera 530, the receiver 560, the codec 540, and the transmitter 550 may represent a pipeline of processing operations performed on the reference video. Video may be taken from a selected point in this pipeline to serve as a test video from which the PVQ scores may be estimated. As discussed, if PVQ scores of a given processing pipeline indicate that quality of the test video is below a desired value, operation of the pipeline may be revised to improve the PVQ scores.

The foregoing discussion has described operations of aspects of the present disclosure in the context of video systems and network channels. Commonly, these components are provided as electronic devices. Video systems and network channels can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs are typically stored in physical storage media such as electronic-based, magnetic-based storage devices, and/or optically-based storage devices, where they are read into a processor and executed. Decoders are commonly packaged in consumer electronic devices, such as smartphones, tablet computers, gaming systems, DVD players, portable media players, and the like. They can also be packaged in consumer software applications such as video games, media players, media editors, and the like. And, of course, these components may be provided as hybrid systems with distributed functionality across dedicated hardware components and programmed general-purpose processors, as desired.

Video systems, including encoders and decoders, may exchange video through channels in a variety of ways. They may communicate with each other via communication and/or computer networks as illustrated in FIG. 1. In still other applications, video systems may output video data to storage devices, such as electrical, magnetic and/or optical storage media, which may be provided to decoders sometime later. In such applications, the decoders may retrieve the coded video data from the storage devices and decode it.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method of measuring a similarity between a test video and a reference video, comprising:
computing pairs of gradient maps, each pair comprises a gradient map of a frame of the test video and a gradient map of a corresponding frame of the reference video;
computing quality maps based on the pairs of gradient maps;
identifying saliency regions of frames of the test video;
deriving a video similarity metric from the quality maps, using quality map values within the identified saliency regions; and
estimating a perceptual video quality score from the video similarity metric.

2. The method of claim 1, wherein the reference video is video input to a video processing system that alters video content and the test video is video output from the video processing system, and the method further comprises adjusting parameters of the video processing system based on the perceptual video quality score.

3. The method of claim 1, wherein the reference video is video input to a video compression system that alters bandwidth of video and the test video is video recovered from compressed video, and the method further comprises adjusting parameters of the video compression system based on the perceptual video quality score.

4. The method of claim 1, wherein the reference video is video input to a video transmission system and the test video is video output from the video transmission system.

5. The method of claim 1, further comprising, before computing gradient maps or quality maps, preprocessing the test video and the reference video, wherein the preprocessing is at least one of a subsampling operation and a filtering operation.

6. The method of claim 1, wherein the saliency regions are determined from the quality maps.

7. The method of claim 1, wherein the saliency regions are determined from the pairs of gradient maps.

8. The method of claim 1, wherein the deriving a video similarity metric from the quality maps comprises using a sample standard deviation of values of the quality maps.

9. The method of claim 1, wherein the estimating the perceptual video quality score is performed from a motion metric.

10. The method of claim 1, wherein the estimating is performed by one or more of a linear regression classifier, a support vector machine, or a neural network.

11. The method of claim 1, wherein the identifying saliency regions comprises:
identifying saliency region categories;
deriving multiple video similarity metrics, each video similarity metric derived from the quality maps, using quality maps' values within a category of saliency regions of the saliency region categories; and
estimating, by a classifier, the perceptual video quality score from the derived multiple video similarity metrics.

12. Computer readable medium storing program instructions that, when executed by a processing device, cause the device to estimate similarity between a test video and a reference video by:
computing pairs of gradient maps, each pair comprises a gradient map of a frame of the test video and a gradient map of a corresponding frame of the reference video;
computing quality maps based on the pairs of gradient maps;
identifying saliency regions of frames of the test video;
deriving a video similarity metric from the quality maps, using quality map values within the identified saliency regions; and
estimating a perceptual video quality score from the video similarity metric.

13. The medium of claim 12, wherein the reference video is video input to a video processing system that alters video content and the test video is video output from the video processing system, and the processing device adjusts parameters of the video processing system based on the perceptual video quality score.

14. The medium of claim 12, wherein the reference video is video input to a video compression system that alters bandwidth of video and the test video is video recovered from compressed video, and the processing device adjusts parameters of the video compression system based on the perceptual video quality score.

15. The medium of claim 12, wherein the reference video is the output of a first system and the test video is the output of a second system, further comprising:
adjusting parameters of the second system based on the perceptual video quality score.

16. The medium of claim 12, wherein, before computing gradient maps or quality maps, the processing device preprocesses the test video and the reference video by at least one of a sub sampling operation and a filtering operation.

17. The medium of claim 12, wherein the processing device determines saliency regions from the quality maps.

18. The medium of claim 12, wherein the processing device determines saliency regions from the pairs of gradient maps.

19. The medium of claim 12, wherein the deriving a video similarity metric from the quality maps comprises using a sample standard deviation of values of the quality maps.

20. The medium of claim 12, wherein the processing device estimates the perceptual video quality score operating as one or more of a linear regression classifier, a support vector machine, or a neural network.

21. The medium of claim 12, wherein the processing device identifies saliency regions by:
identifying saliency region categories;
deriving multiple video similarity metrics, each video similarity metric derived from the quality maps, using quality maps' values within a category of saliency regions of the saliency region categories; and
estimating, by a classifier, the perceptual video quality score from the derived multiple video similarity metrics.
